(19) United States
(12) Patent Application Publication
(10) Pub. No.: US 2011/0073585 A1
(43) Pub. Date: Mar. 31, 2011

(54) Device for Heating a Fluid Transfer Line

(75) Inventors: YANN SINAULT, MONTARGIS (FR); DENIS GODEAU, VIEILLES MAISONS (FR); THIERRY BENARD, CHECY (FR)

(73) Assignee: Hutchinson

(21) Appl. No.: 12/893,414

(22) Filed: Sep. 29, 2010

(30) Foreign Application Priority Data
Sep. 29, 2009 (FR) 09 04632

(51) Int. Cl. H05B 3/08

(52) U.S. Cl. 219/541

(57) ABSTRACT

The present invention concerns a device for heating a fluid transfer line (L) including at least one pipe and at least two pipe connectors to be heated which are mounted at the ends of the line.

This device (1) includes:
said connectors (3 and 4), which include at least one first connector (5) at one end (L1) and optionally between two consecutive pipes and a second connector (6) at an end (L2),
at least one pair of metal heating elements (14₁ and 14₂) for the or each pipe connected to the or each first connector, the pair of heating elements adjacent to the second end being further connected to the second connector, and
electrical power supply means (12₁ and 12₂) configured to power the first connector at the first end.

According to the invention, the or each first connector (5) incorporates electrical connection means (5₁, 5₂) connected to the heating elements to connect them to the power supply means and the second connector (6) incorporates means (6₁₂) for closing the circuit formed by the pair or pairs of heating elements and by these connection means, so that the or each pipe heats the corresponding connectors via these connection and closure means.

### FIELD OF THE INVENTION

The present invention concerns a device for heating a fluid transfer line including at least one pipe and at least two pipe connectors mounted at opposite first and second ends of the line. The invention applies notably to a fluid transfer line for automobile vehicles the content of which needs to be heated.

### BACKGROUND OF THE INVENTION

Quick-release connection systems in automobile vehicles generally have the function of connecting fluid transfer pipes to parts of the engine. Many parts of an automobile vehicle must be heated, notably when starting, for reasons of efficiency, pollution and/or passenger comfort. To this end, the pipe, the quick-release connection system or both at once can be heated as required via two separate heating devices, the latter option having the disadvantage of requiring separate electrical connectors for heating the pipe and the connection system and possibly devices for protecting against overheating and/or different automatic regulator devices for the pipe and for the connection system.

There may be cited for example the document WO-A2-2008/151924 that teaches helically winding two heating wires along a pipe and disposing the ends of these wires in a quick-release connection system to heat the connector as well.

### SUMMARY OF THE INVENTION

An object of the present invention is to propose a device for heating a fluid transfer line, that line including at least one pipe and at least two pipe connectors to be heated which are mounted at opposite first and second ends of the line, this device eliminating the above drawback and including:

said connectors, which include at least one first connector intended to be mounted at said first end and optionally between two consecutive pipes in the case of pipes connected in series and a single second connector intended to be mounted at said second end,

at least one pair of metal heating elements (wires, by way of nonlimiting example) which are intended to be disposed along the or each pipe and which are connected to the or each first connector, the pair of heating elements adjacent to said second end being further connected to the second connector, and

electrical power supply means configured to power the first connector at said first end.

To this end, in a device of the invention, the or each first connector incorporates electrical connection means which are connected to the corresponding pair of heating elements to connect it electrically to the power supply means, and the single second connector incorporates means for closing the electrical circuit formed by the pair or pairs of heating elements and by these connection means, so that the or each pipe heats the corresponding connectors via these connection and closure means.

It will be noted that in the device of the invention it is the heating elements disposed along the or each pipe that heat these connection and closure means and thus the corresponding connectors, essentially by thermal conduction and/or by the Joule effect. In this regard, these connection and closure means are produced in an appropriate material to promote this thermal conduction.

It will also be noted that the connectors of the device of the invention heated in this way may all be connection inserts or terminals, for example a simple male or female terminal equipped with these connection means or these closure means, or a quick-release connection system element.

It will further be noted that the material of these first and second connectors of the invention to be heated may be adapted to facilitate heat transfer by conduction from the heating elements, consisting by way of nonlimiting example of a thermally conductive plastic.

These electrical connection means and circuit closure means are thus advantageously adapted to be heated by n pipes of the line (where n is an integer equal to or greater than 1) via:

electrical connections between, on the one hand, the pair of heating elements of the or each pipe and, on the other hand, the electrical connection means or the closure means, depending on the position of the pipe in the line, and

electrical cables which include the power supply means and are connected to the electrical connection means of the first connector to be heated at said first line end.

If n is equal to or greater than two (i.e. for at least two pipes), two consecutive pipes are connected together via the respective electrical connection means which equip two first adjacent intermediate connectors to be heated and are themselves electrically connected to each other by two coupled electrical connectors.

According to another feature of the invention, said electrical connection means may include two separated metal contacts that are respectively connected, on the one hand, to the two electrical cables and, on the other hand, to the two heating elements of said or each pair by said electrical connections and said circuit closure means may then include a single metal contact that is connected to the corresponding two heating elements.

Each of said contacts is preferably in the form of a cylindrical sector mounted around the corresponding connector to be heated and is locked in a circumferential groove on the latter, the two contacts of said electrical connection means being diametrically opposite each other.

The or each electrical connection with which each contact is provided to receive a heating element may advantageously be fastened to this contact and extend it axially toward the adjacent connector to be heated.

According to another feature of the invention, at least one of said contacts may further support a thermal protection component and/or another heating component, for example with a positive temperature coefficient, so as to provide protection against overheating, automatic regulation of the temperature in the line and/or to add heating power locally, respectively.

According to another feature of the invention, each of the first and second connectors to be heated provided with the corresponding contact or contacts may be covered by an electrically insulative bush defining the radially external envelope of the corresponding connector and is provided with an axial spigot for connecting it to the corresponding pipe. This bush may be fluid-tight and may be overmolded or otherwise attached, and in the latter case optionally adhesively bonded.

According to another, optional feature of the invention, a clip-on quick-release connection system may be mounted via this bush on at least one of these connectors to be heated to form a quick-release connection system, this quick-release connection system being optionally provided with a device for indicating correct connection of a male terminal into this quick-release connection system.

The or each pair of heating elements preferably includes two heating wires that are wound in a cylindrical helix and preferably intended to be mounted radially outside the corresponding pipe.

According to another aspect of the invention, said heating device further incorporates the or each pipe of said line to be heated, which pipe is preferably produced in a plastic material.

It is even more preferable if said or each pair of heating wires is wound in a cylindrical helix radially outside and in contact with the corresponding pipe, a thermally insulative sleeve surrounding the or each pipe provided with these wires. This bush then advantageously connects said clip-on quick-release connection system to this sleeve so as to fasten the corresponding pipe and the quick-release connection system.

### BRIEF DESCRIPTION OF THE DRAWINGS

Other features, advantages and details of the present invention will emerge on reading the following description of embodiments of the invention, said description being given by way of illustrative and nonlimiting example with reference to the appended drawings, in which:

FIG. 1 is a partial diagrammatic view in axial section of a heating device of one embodiment of the invention in relation with a pipe of the line to be heated, only the first connector to be heated defining a first end of the line being visible therein,

FIG. 2 is a perspective view of a heating device conforming to the principle of FIG. 1, in the case of a line with only one pipe (not shown), also showing the second connector to be heated at a second end of the line,

FIG. 3 is a diagrammatic plan view showing a heating device that is a variant of the FIG. 2 device generalizing the invention to a line with two pipes connected in series, showing the insertion between the first and second line ends of two other first connectors for connecting these two pipes together and heated by the latter, and

FIG. 4 is a diagrammatic partial perspective view showing details of the device from FIG. 3, the two pipes that heat the two intermediate connectors and the two end connectors not being visible.

### DETAILED DESCRIPTION

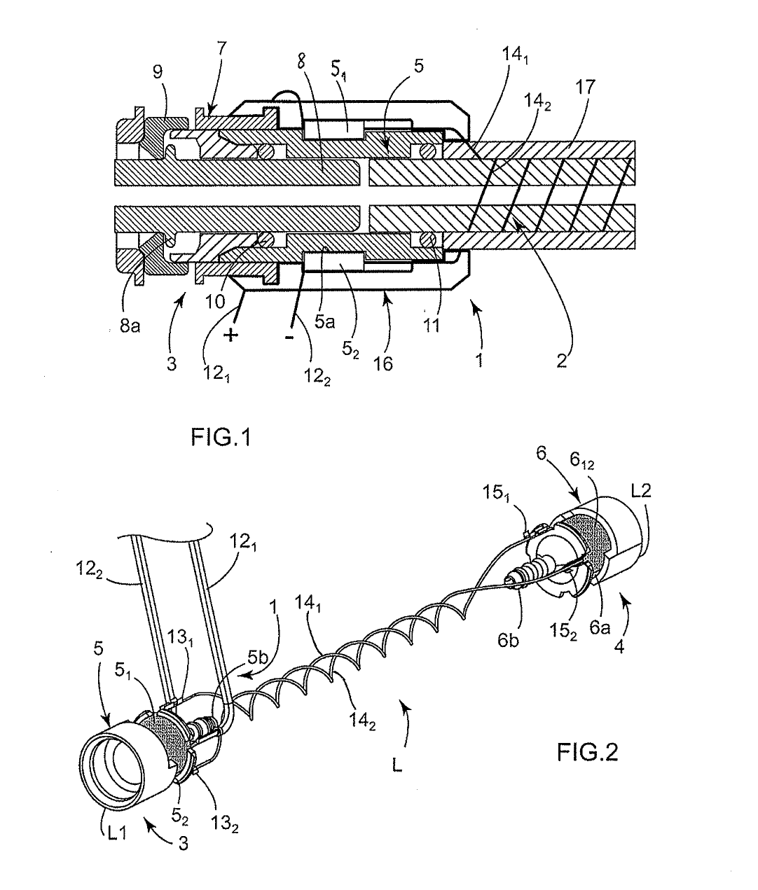

The heating device 1 from FIGS. 1 and 2 is adapted to heat at the same time a single pipe 2 and first and second quick-release connection systems 3 and 4 including respective first and second connectors 5 and 6 to be heated between which this pipe 2 is mounted and which thus define the opposite first and second ends L1 and L2 of the fluid transfer line L. As previously indicated, it will be noted that these connectors 5 and 6 could be simple connection inserts, for example male terminals, instead of the quick-release connection systems 3 and 4.

In the FIG. 1 example, the first connector 5 to be heated is used in conjunction with a clip-on quick-release connection system 7 into which is locked a male terminal 8 provided with a peripheral locking projection 8a and with a device 9 for indicating correct connection of this male terminal 8 in the quick-release connection system 7. This indicator device 9 may for example be that described in the patent EP-B1-1 770 321 or the patent application filed under the number FR0902113,both in the name of the Applicant. As can be seen in FIG. 1, in this example a first seal 10 is disposed radially between the connector 5 and this male terminal 8 and a second seal 11 is disposed radially between this connector 5 and the pipe 2.

This first heated connector 5 (visible on the left in FIG. 2) has a circumferential groove 5a to which are welded or crimped, for example, two metal heating contacts 5₁ and 5₂ each of cylindrical arc shape the edges of which espouse those of the groove and which are spaced on the circumference of the latter and diametrically opposite each other (these contacts 5₁ and 5₂ may be mounted other than by welding or crimping). These contacts 5₁ and 5₂ are respectively connected, on the one hand, to two electrical power supply cables 12₁ and 12₂ and, on the other hand, by electrical connections 13₁ and 13₂ to two heating wires 14₁ and 14₂ intended to be disposed along the pipe 2. Moreover, this connector 5 is provided at its axial end facing toward the pipe 2 with a spigot 5b for connecting it to this pipe 2, for example a spigot of barbed shape.

As for the second connector 6 to be heated (visible on the right in FIG. 2), it incorporates circuit closure means formed of a single metal contact 6₁₂ of cylindrical arc shape which is for example welded or crimped to a groove 6a on the connector 6 like the two contacts 5₁ and 5₂ of the connector 5 and which closes the electrical circuit because it is itself connected to the two adjacent ends of the heating wires 14₁ and 14₂ by electrical connections 15₁ and 15₂. Moreover, this connector 6 is provided at its axial end facing toward the pipe 2 with a terminal 6b for connecting it to this pipe 2 similar to the previous one.

The electrical connections 13₁, 13₂, 15₁, 15₂ between each contact 5₁, 5₂, 6₁₂ and the heating wire or wires 14₁ and 14₂ are in this example of the pin type axially extending the corresponding contact 5₁, 5₂, 6₁₂ toward the opposite connector 5, 6 to be heated. It should nevertheless be noted that these connections 13₁, 13₂, 15₁, 15₂ could be structured differently, provided that the heating wires 14₁ and 14₂ can be electrically powered by the current fed by the two cables 12₁ and 12₂ (which could of course be arranged in a different manner to that shown in FIG. 2, given that it is necessary and sufficient for these cables 12₁ and 12₂ to define + and − poles in relation to the two contacts 5₁ and 5₂ of the first connector 5).

As shown in FIG. 1, the two heating wires 14₁ and 14₂ are preferably wound in the form of a cylindrical helix on the radially external face of the pipe 2, which may by way of nonlimiting example be produced in a thermoplastic material such as a polyamide (for example PA12). It will nevertheless be noted that it would be possible in the context of the present invention to provide this winding of heating wires 14₁ and 14₂ elsewhere than on the exterior of the pipe 2, for example in the wall of the latter.

As also shown in FIG. 1, this connector 5 to be heated and the contacts 5₁ and 5₂ that it incorporates are covered by an electrically insulative bush 16 that defines the radially external envelope of the corresponding quick-release connection system 3 and which, in this example, fixes this connection system 3 to the pipe 2 by gripping a thermally insulative flexible sleeve 17 mounted around this pipe 2 so as to surround the heating wires 14₁ and 14₂ axially as far as the facing end of this bush 16.

Thus it is clear that the electrical power supply to each of the two contacts 5₁ and 5₂ of the first connector 5, which contacts 5₁ and 5₂ are electrically connected to the two wires 14₁ and 14₂, respectively, extending along the pipe 2, makes it possible:

to heat the pipe 2 because these electrically powered contacts 5₁ and 5₂ are respectively connected to the wires 14₁ and 14₂ and the single contact 6₁₂ equipping the second connector 6 closes the electrical circuit, and then to heat these contacts 5₁, 5₂, 6₁₂ and thus the connectors 5 and 6 incorporating them, and, optionally

to have these contacts 5₁, 5₂, 6₁₂ serve to support a thermal protection component (for example a positive temperature coefficient (PTC) component, not shown) and/or serve to support another heating component (also a PTC component, for example).

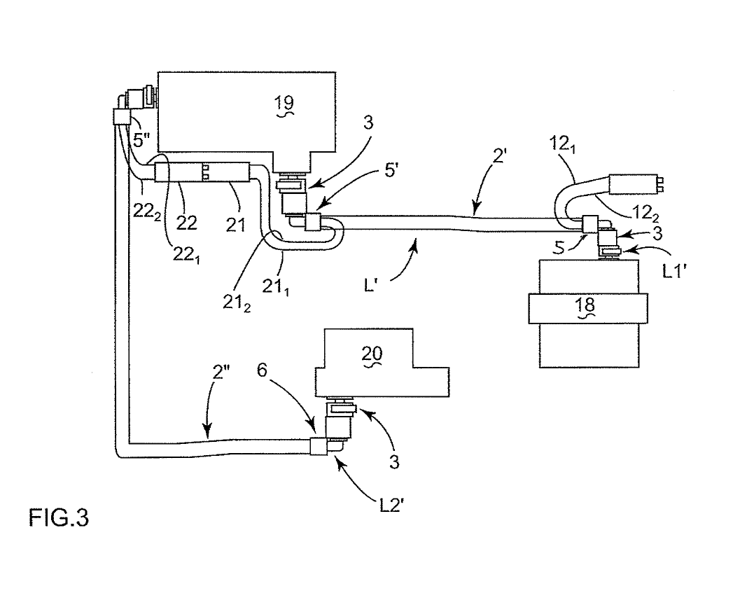

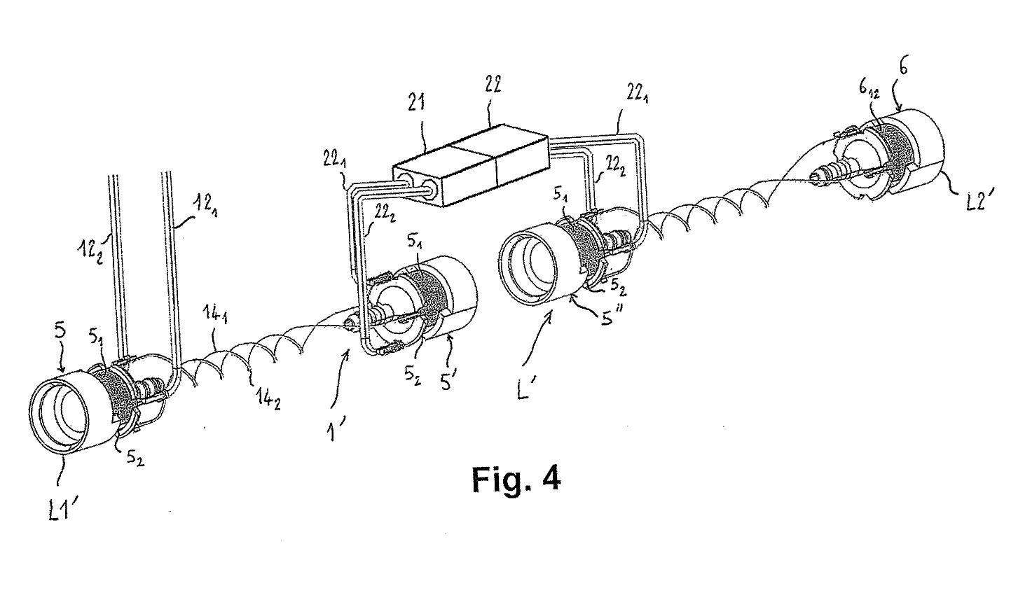

In the variant of the invention shown in FIGS. 3 and 4, the line L′ heated by the device 1′ of the invention comprises:

two pipes 2′ and 2″ of which one pipe 2′ is disposed between first and second parts 18 and 19 of an automobile vehicle and the other pipe is disposed between the second part 19 and a third part 20 of the vehicle (only the pairs of wires 14₁ and 14₂ for heating them can be seen in FIG. 4), and

four connectors 5, 5′, 5″ and 6 to be heated that are for example included in quick-release connection systems of these pipes 2′ and 2″ and that comprise two first intermediate connectors 5′ and 5″ each connected to a pipe 2′, 2″.

To be more precise, this device 1′ includes:

two first connectors 5 and 5′ to be heated at the ends of the pipe 2′ (i.e. each with two separate contacts 5₁ and 5₂ respectively connected to the two wires 14₁ and 14₂ of this pipe 2′), of which one 5 forms the first line end L1′ and is therefore electrically powered by the cables 12₁ and 12₂ and of which the other 5′ occupies an intermediate position in the line L′, each of these connectors 5, 5′ being similar to that described above with reference to FIGS. 1 and 2,

another first connector 5″ to be heated at an intermediate position in the line L′, mounted at the end of the other pipe 2″ adjacent to the connector 5′, and connected to the latter by male and female electrical connectors 21 and 22 plugged one into the other and respectively provided with cables 21₁, 21₂ and 22₁, 22₂ for connecting them to the contacts 5₁ and 5₂ of the connectors 5′ and 5″, and

a single second heated connector 6 at the other line end L2′ (i.e. with a single contact 6₁₂ connected to the two adjacent wires 14₁ and 14₂ so as to close the electrical circuit powered by the cables 12₁ and 12₂) that is identical to that from FIG. 2, for example.

It will be noted that this device 1′ from FIGS. 3 and 4 advantageously includes only one electrical power supply 12₁ and 12₂ for both the heating pipes 2′ and 2″. It is therefore clear that it is possible using the device 1′ of the invention to heat satisfactorily the whole of the line L′ (pipes and quick-release connection systems inclusive) with a single pair of electrical power supply cables 12₁ and 12₂.

It will also be noted that this variant of FIGS. 3 and 4 may be generalized in the same manner to more than two heating pipes, given that it is sufficient to add between two consecutive heating pipes a pair of electrical connectors 21, 22 respectively connected to the two contacts 5₁ and 5₂ of the corresponding first intermediate connectors.

1. A device for heating a fluid transfer line, the fluid transfer line including at least one pipe and at least two pipe connectors to be heated which are mounted at opposite first and second ends of the line, the device including:
said connectors, which include at least one first connector configured to be mounted at said first end and optionally between two consecutive pipes in the case of pipes connected in series and a single second connector configured to be mounted at said second end,
at least one pair of metal heating elements which are configured to be disposed along the or each pipe and which are connected to the or each first connector, the pair of heating elements adjacent to said second end being further connected to the second connector, and
electrical power supply means configured to power the first connector at said first end,
wherein said first connector incorporates electrical connection means which are connected to the corresponding pair of heating elements to connect said first connector electrically to the power supply means, and in that the single second connector incorporates means for closing the electrical circuit formed by the pair or pairs of heating elements and by these connection means, so that said at least one pipe heats the corresponding connectors via these connection and closure means.

2. Heating device according to claim 1, wherein said electrical connection means and said circuit closure means are adapted to be heated by n pipes (where n is an integer equal to or greater than 1) of the fluid transfer line via:
electrical connections between, on the one hand, the pair of heating elements of the or each pipe and, on the other hand, the electrical connection means or the closure means, depending on the position of the pipe in the line, and
electrical cables which include the power supply means and that are connected to the electrical connection means of the first connector to be heated situated at said first line end.

3. Heating device according to claim 2, wherein if n is equal to or greater than two, two consecutive pipes are connected together via the respective electrical connection means which equip two of said first adjacent intermediate connectors to be heated and are themselves electrically connected to each other by two coupled electrical connectors.

4. Heating device according to claim 2, characterized in that said electrical connection means include two separated metal contacts that are respectively connected, on the one hand, to the two electrical cables (and, on the other hand, to the two heating elements of said or each pair by said electrical connections (and said circuit closure means include a single metal contact that is connected to the corresponding two heating elements.

5. Heating device according to claim 4, characterized in that each of said contacts (is in the form of a cylindrical sector mounted around the corresponding connector to be heated and is locked in a circumferential groove on the latter, the two contacts of said electrical connection means being diametrically opposite each other.

6. Heating device according to claim 5, characterized in that the or each electrical connection with which each contact is provided to receive a heating element that is fastened to this contact and extends it axially toward the adjacent connector.

7. Heating device according to claim 4, characterized in that at least one of said contacts further supports a thermal protection component and/or another heating component so as to provide protection against overheating, automatic regulation of the temperature in the line and/or to add heating power locally, respectively.

8. Heating device according to claim 4, characterized in that each of the first and second connectors to be heated provided with the corresponding contact or contacts is covered by an electrically insulative bush defining the radially external envelope of the corresponding connector and is provided with an axial spigot for connecting it to the corresponding pipe.

9. Heating device according to claim 8, characterized in that a clip-on quick-release connection system is mounted via said bush on at least one of these connectors to be heated, to form a quick-release connection system, the quick-release connection system being optionally provided with a device for indicating correct connection of a male terminal into this quick-release connection system.

10. Heating device according to claim 1, characterized in that said or each pair of heating elements includes two heating wires that are wound in a cylindrical helix and are configured to be mounted radially outside the corresponding pipe.

11. Heating device according to claim 1, characterized in that it further incorporates the or each pipe of said line to be heated.

12. Heating device according to claim 10, wherein said or each pair of heating wires is wound in a cylindrical helix radially outside and in contact with the corresponding pipe, a thermally insulative sleeve surrounding the or each pipe provided with these wires.

13. Heating device according to claim 9, characterized in that said bush connects the clip-on quick-release connection system to this sleeve so as to fasten it to the or each pipe.
